(19) United States
(12) Patent Application Publication
(10) Pub. No.: US 2016/0261760 A1
(43) Pub. Date: Sep. 8, 2016

(54) ELECTRONIC DEVICE, COMMUNICATION MODE CONTROL METHOD, AND COMMUNICATION MODE CONTROL PROGRAM

(71) Applicants: Takahiro ASO, Tokyo (JP); Yuuta SAITOH, Tokyo (JP)

(72) Inventors: Takahiro ASO, Tokyo (JP); Yuuta SAITOH, Tokyo (JP)

(73) Assignee: Ricoh Company, Ltd., Tokyo (JP)

(21) Appl. No.: 15/046,811

(22) Filed: Feb. 18, 2016

(30) Foreign Application Priority Data
Mar. 4, 2015 (JP) 2015-042116

(51) Int. Cl. H04N 1/00; H04W 76/06; G06K 9/00; H04W 4/00

(52) U.S. Cl. CPC H04N 1/00307; H04W 4/008; H04W 76/064; G06K 9/00369; H04N 1/00891; H04N 2201/0094

(57) ABSTRACT

An electronic device includes a processor, the processor including a communication unit that carries out a communication mode in which the electronic device and a terminal device communicate with each other directly, a human body detection unit that detects proximity of a user to the electronic device, and a network control unit that activates, in response to a notification of the proximity of the user detected by the human body detection unit, the communication mode by the communication unit in which the electronic device and the terminal device communicate with each other directly.

### CROSS-REFERENCE TO RELATED APPLICATION

The present application is based upon and claims the benefit of priority of Japanese Patent Application No. 2015-042116, filed on Mar. 4, 2015, the contents of which are incorporated herein by reference in their entirety.

### BACKGROUND OF THE INVENTION

1. Field of the Invention

The present invention relates to an electronic device, a communication mode control method, and a communication mode control program.

2. Description of the Related Art

Portable terminal devices, such as smart phones and tablets, are increasingly popular. The need for printing data by transferring the data from a portable terminal device to an image forming apparatus, such as a multi-function peripheral (MFP), and the need for transferring data from a portable terminal device to other electronic devices are growing.

Wi-Fi Direct is known as a method of ad hoc networking for transferring electronic data directly between an electronic device such as an image forming apparatus, and a terminal device carried by a user. Wi-Fi Direct is one of wireless LAN functions and provides a wireless communication mode which transfers data directly between the devices without requiring a wireless LAN access point or a wireless LAN router. Because neither a wireless LAN access point nor a wireless LAN router is required, Wi-Fi Direct can provide a wireless connection to various devices even if the devices are not permitted beforehand for network access.

Generally, a Wi-Fi Direct system according to the related art operates in a manner similar to a wireless access point. If the Wi-Fi Direct system is activated at all times, the frequency range of radio waves will be taken up and the power consumption will be increased. To avoid the problem, a common method of operating the Wi-Fi Direct system is that a user activates the Wi-Fi Direct system temporarily. Regarding the related art, see Japanese Laid-Open Patent Publication No. 2005-244329.

### SUMMARY OF THE INVENTION

In one aspect, the present invention provides an electronic device which is capable of providing improved operability and reduced power consumption.

In one embodiment, the present invention provides an electronic device including a processor, the processor including: a communication unit configured to carry out a communication mode in which the electronic device and a terminal device communicate with each other directly; a human body detection unit configured to detect proximity of a user to the electronic device; and a network control unit configured to activate, in response to a notification of the proximity of the user detected by the human body detection unit, the communication unit to carry out the communication mode in which the electronic device and the terminal device communicate with each other directly.

The object and advantages of the invention will be implemented and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

FIG. 1 is a block diagram showing a configuration of a system according to an embodiment.

FIG. 2 is a diagram showing an outline configuration of an image forming apparatus according to an embodiment.

FIG. 3 is a block diagram showing a hardware configuration of the image forming apparatus.

FIG. 4 is a diagram for explaining an example of detection of the proximity and secession of a person by a human body detection sensor.

FIG. 5 is a block diagram showing a software configuration of the image forming apparatus.

FIG. 6 is a block diagram showing a hardware configuration of a terminal device.

FIG. 7 is a block diagram showing a software configuration of the terminal device.

FIG. 8 is a diagram showing an example of a setting screen related to Wi-Fi Direct mode switching.

FIG. 9 is a flowchart for explaining a process performed by a network control unit of the image forming apparatus.

FIG. 10A and FIG. 10B are diagrams showing examples of screens displayed by an operation unit.

FIG. 11 is a sequence diagram for explaining a process performed by the system according to the embodiment.

FIG. 12 is a sequence diagram for explaining a process performed by the system according to the embodiment.

FIG. 13 is a sequence diagram for explaining a process performed by the system according to a modified embodiment.

FIG. 14 is a sequence diagram for explaining a process performed by the system according to a modified embodiment.

### DETAILED DESCRIPTION OF THE PREFERRED EMBODIMENTS

A description will be given of embodiments with reference to the accompanying drawings.

In the following, an image forming apparatus 1 will be described as an example of an electronic device according to the invention. However, it can be readily understood that the electronic device according to the invention is also applicable to electronic devices other than the image forming apparatus.

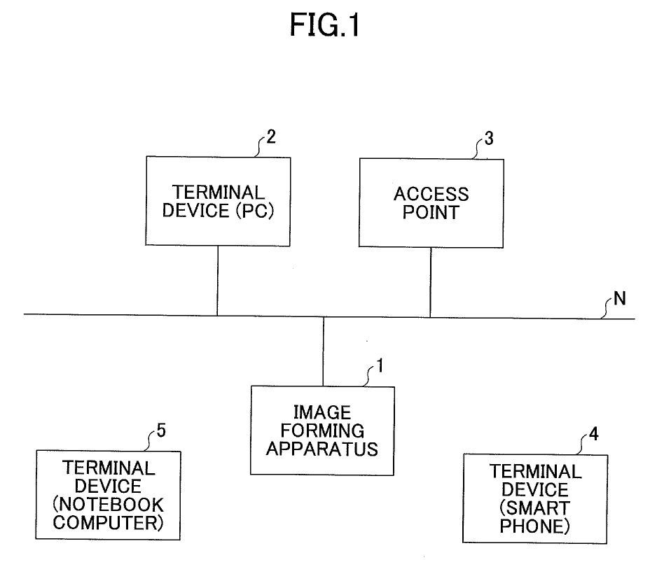

FIG. 1 shows a configuration of a system according to an embodiment. As shown in FIG. 1, an image forming apparatus 1 such as a multi-function peripheral (MFP), a terminal device 2 such as a personal computer (PC), and a wireless LAN access point 3 are connected to a wired network N. The image forming apparatus 1 may include a wired communication interface and a wireless communication interface. The terminal device 2 may include a wired communication interface. The access point 3 is a networking hardware device that allows wireless devices to connect to the wired network N by radio.

Further, in the system shown in FIG. 1, a terminal device 4 such as a smart phone, and a terminal device 5 such as a notebook computer are provided as portable terminal devices having wireless communication interfaces. The terminal devices 4 and 5 are configured to connect to the network N via the access point 3 by radio. By making use of Wi-Fi Direct, the terminal devices 4 and 5 and the image forming apparatus 1 are configured to communicate directly with each other.

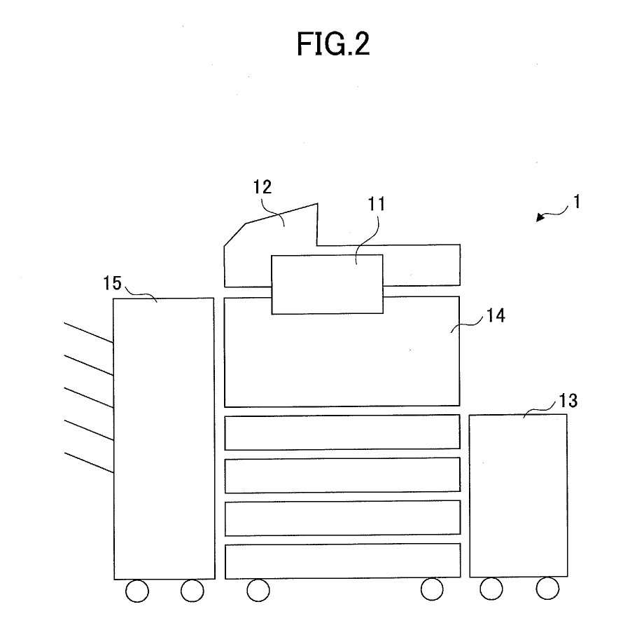

FIG. 2 shows an outline configuration of the image forming apparatus 1. As shown in FIG. 2, the image forming apparatus 1 may include an operation panel 11, a document scanning unit 12, a paper feeding unit 13, a printing unit 14, and a paper ejection unit 15.

The operation panel 11 is a hardware unit that displays a state of the image forming apparatus 1 to a user and receives a request from a user. The document scanning unit 12 is a hardware unit that optically reads an original image or data from a document from which a copy is reproduced. The paper feeding unit 13 is a hardware unit that supplies a sheet to be printed. The printing unit 14 is a hardware unit that prints an image on the sheet from the paper feeding unit 13 based on the original image or data read by the document scanning unit 12. The paper ejection unit 15 is a hardware unit that ejects the sheet on which the image is printed by the printing unit 14.

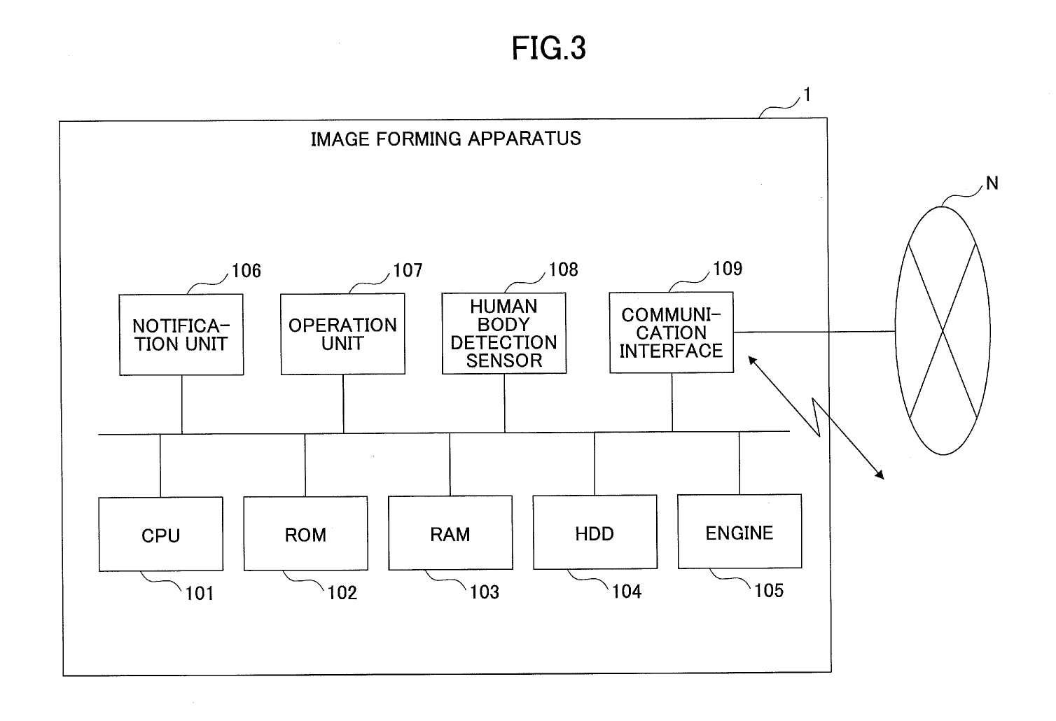

FIG. 3 shows a hardware configuration of the image forming apparatus 1. As shown in FIG. 3, the image forming apparatus 1 may include a central processing unit (CPU) 101, a read-only memory (ROM) 102, a random access memory (RAM) 103, a hard disk drive (HDD) 104, an engine 105, a notification unit 106, an operation unit 107, a human body detection sensor 108, and a communication interface 109, which are interconnected by a bus.

The CPU 101 is a processor configured to control overall operations of the image forming apparatus 1. The CPU 101 is configured to execute programs read from the ROM 102 or the HDD 104 to the RAM 103 by using the RAM 113 as a work area.

The engine 105 is a hardware unit configured to perform a reading operation and a printing operation and implement various image forming functions, including a copier function, a scanner function, a fax function, a printer function, etc.

The notification unit 106 is a hardware unit configured to provide a user with a state of the image forming apparatus 1. Examples of the notification unit 106 may include a LED (light emitting diode), a Patlite®, a buzzer, etc.

The operation unit 107 is a user interface unit configured to receive an input operation from a user and display information of a state of the image forming apparatus 1 to a user.

The human body detection sensor 108 is a sensor configured to detect the proximity of a person to the image forming apparatus 1 and the secession (or withdrawal) of a person from the image forming apparatus 1.

The communication interface 109 is an interface unit connected to the network N by wire and configured to connect to an external wireless device by radio.

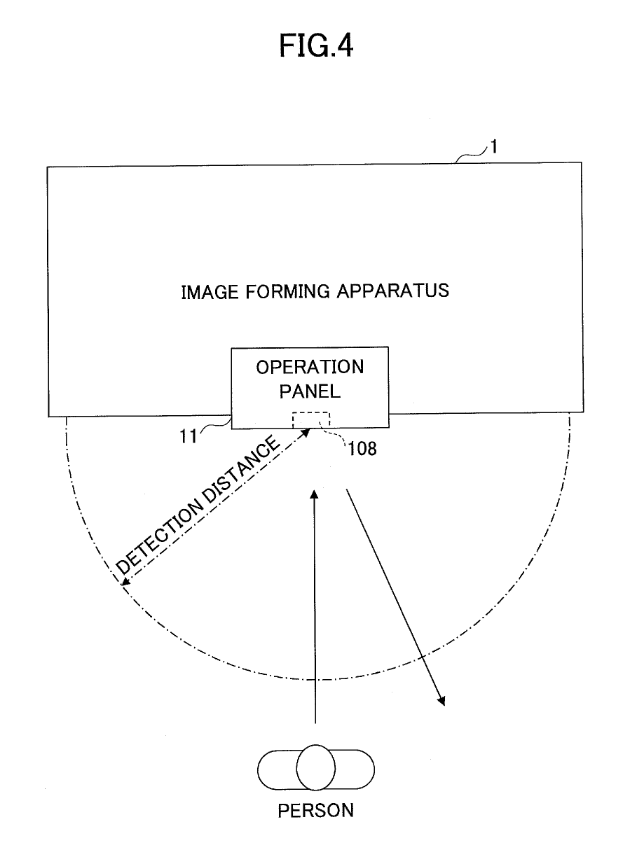

FIG. 4 is a diagram for explaining an example of detection of the proximity and secession of a person by the human body detection sensor 108. In the example shown in FIG. 4, the human body detection sensor 108 is incorporated in the operation panel 11 of the image forming apparatus 1. The human body detection sensor 108 detects the proximity of a person to the image forming apparatus 1 when the person approaches and enters a region of a detection distance of the human body detection sensor 108. The human body detection sensor 108 detects the secession of a person from the image forming apparatus 1 when the person leaves and goes out of the region of the detection distance.

Note that the location where the human body detection sensor 108 is disposed is not limited to the inside of the operation panel 11 and it may be any other portion of the image forming apparatus 1. The human body detection sensor 108 may be disposed at a location distant from the image forming apparatus 1 and may connect to the image forming apparatus 1 by wire or by radio. Further, the region in which the proximity and secession of a person can be detected by the human body detection sensor 108 is not be limited to a circular region with an omnidirectional radiation pattern, and it may be an arbitrary-form region with a directional radiation pattern.

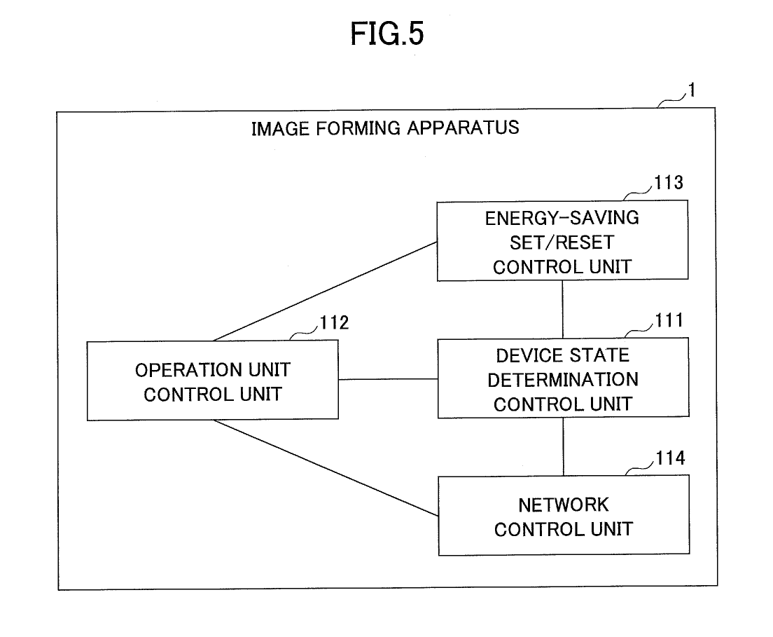

FIG. 5 shows a software configuration of the image forming apparatus 1. As shown in FIG. 5, the image forming apparatus 1 may include a device state determination control unit 111, an operation unit control unit 112, an energy-saving set/reset control unit 113, and a network control unit 114.

The device state determination control unit 111 is configured to control a device state of the image forming apparatus 1. Specifically, the device state determination control unit 111 according to this embodiment is configured to send a notification of proximity information (notification of proximity) to a related control unit in response to a trigger of the proximity of a person received from the human body detection sensor 108, and send a notification of secession information (notification of secession) to the related control unit in response to a trigger of the secession of the person received from the human body detection sensor 108.

The operation unit control unit 112 is configured to control the operation unit 107 in response to a request from a related control unit, so that the operation unit 107 is controlled to receive an input operation from a user and display information of a state of the image forming apparatus 1 to a user.

The energy-saving set/reset control unit 113 is configured to stop the power supply to the operation unit 107 and the engine 105 in response to an energy-saving mode set request received from the device state determination control unit 111 and start the power supply to the operation unit 107 and the engine 105 in response to an energy-saving mode reset request received from the device state determination control unit 111.

The network control unit 114 is configured to transmit packets to and receive packets from a networking device via the communication interface 109. Further, the network control unit 114 is configured to control the network N in response to a request from a user or from the device state determination control unit 111. Specifically, the network control unit 114 according to this embodiment is configured to switch a wireless LAN communication mode set up by the communication interface 109, in response to a notification of proximity or a notification of secession received from the device state determination control unit 111.

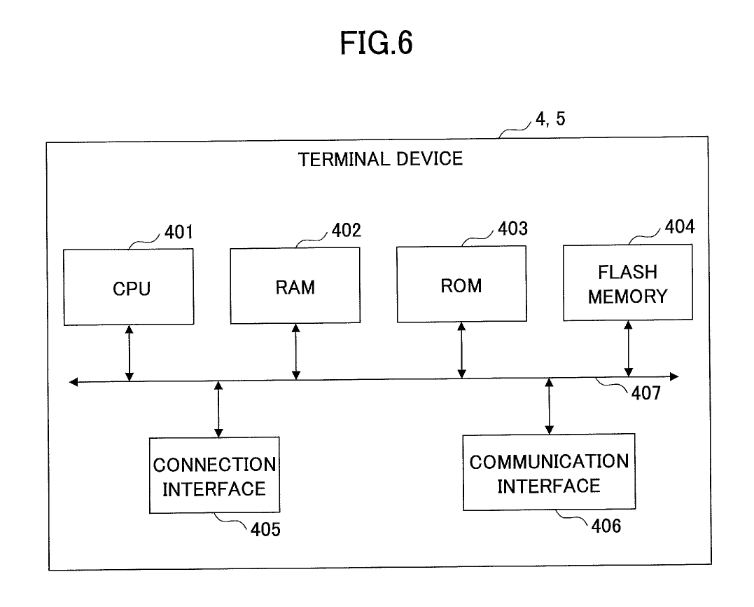

FIG. 6 shows a hardware configuration of each of the terminal devices 4 and 5. As shown in FIG. 6, each of the terminal devices 4 and 5 may include a CPU 401, a RAM 402, a ROM 403, a flash memory 404, a connection interface 405, and a communication interface 406, which are interconnected by a bus 407.

The CPU 401 is a processor configured to control overall operations of the terminal device 4 or 5. The CPU 401 is configured to execute a program read from the ROM 403 or the flash memory 404 to the RAM 402 by using the RAM 402 as a work area.

The connection interface 405 is an interface unit configured to connect the terminal device 4 or 5 with an external device. The communication interface 406 is an interface unit configured to perform communication with another information processing apparatus via the network N.

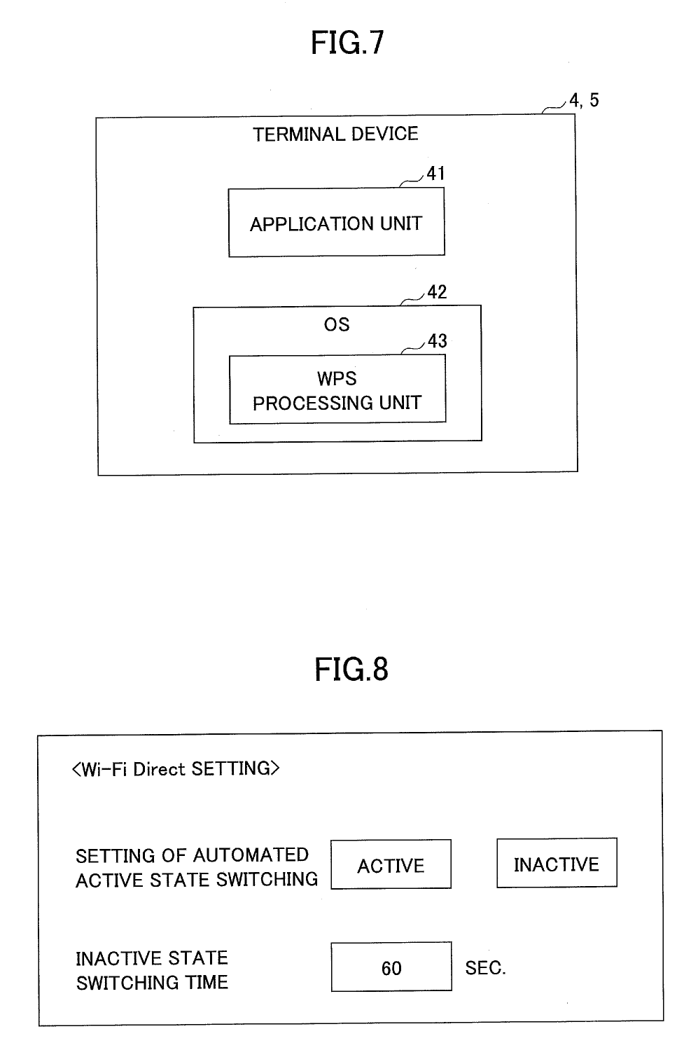

FIG. 7 shows a software configuration of each of the terminal devices 4 and 5. As shown in FIG. 7, each of the terminal devices 4 and 5 may include an application unit 41 and an operating system (OS) 42. The application unit 41 is configured to execute an arbitrary application program installed in the terminal device. The OS 42 includes a WPS (Wi-Fi Protected Setup) processing unit 43. The WPS processing unit 43 is configured to perform a WPS process for simplifying encryption setup between wireless LAN devices.

FIG. 8 shows an example of a setting screen related to Wi-Fi Direct mode switching. In the example shown in FIG. 8, a Wi-Fi Direct setting screen includes a “setting of automated active state switching” portion with an “active” button and an “inactive” button, and an “inactive state switching time” portion with an input area into which the number of seconds related to the inactive state switching time is input by a user. The setting related to the Wi-Fi Direct mode switching may be performed based on the control of the operation unit control unit 112, and setting values may be stored in a storage area of the RAM 103 or the HDD 104 based on the control of the network control unit 114.

When the “active” button in the “setting of automated active state switching” portion of the setting screen is selected by the user, a Wi-Fi Direct mode of the image forming apparatus 1 is automatically activated in response to a notification of proximity of a user received. On the other hand, when the “inactive” button is selected by the user, the activation of the Wi-Fi Direct mode is not performed even if a notification of proximity of a user is received.

The setting of the “inactive state switching time” is allowed only when the “automated active state switching” is in an active state. The “inactive state switching time” is input in the setting screen by the user to set up in the network control unit 114 a value of a timeout interval between an end of a Wi-Fi Direct communication (which may include a case in which the communication is not started) and a time the Wi-Fi Direct mode is to be deactivated after the end of the communication.

Further, regarding the Wi-Fi Direct mode, the setting of a “PIN code connection” mode or a “WPS button” mode is separately performed as the setting of a connection method. When the “PIN code connection” mode is set up, the image forming apparatus 1 generates a PIN (personal identification number) code and displays the PIN code, and the terminal device 4 or 5 which requests a Wi-Fi Direct connection with the image forming apparatus 1 performs the Wi-Fi setting by inputting the PIN code to the terminal device. When the “WPS button” mode is set up, the image forming apparatus 1 displays a SSID (service set identifier) of the image forming apparatus 1 itself and the terminal device 4 or 5 which requests a Wi-Fi Direct connection with the image forming apparatus 1 performs the Wi-Fi setting by pressing a WPS button on the terminal device and selecting the SSID of the image forming apparatus 1. The setting of these modes may also be performed based on the control of the operation unit control unit 112, and setting values may be stored in the storage area based on the control of the network control unit 114.

Note that when the terminal device 4 or 5 and the image forming apparatus 1 may communicate with each other in a power-saving manner, such as by Bluetooth®, it is possible to set the system in a standby state at all times without performing the automated switching.

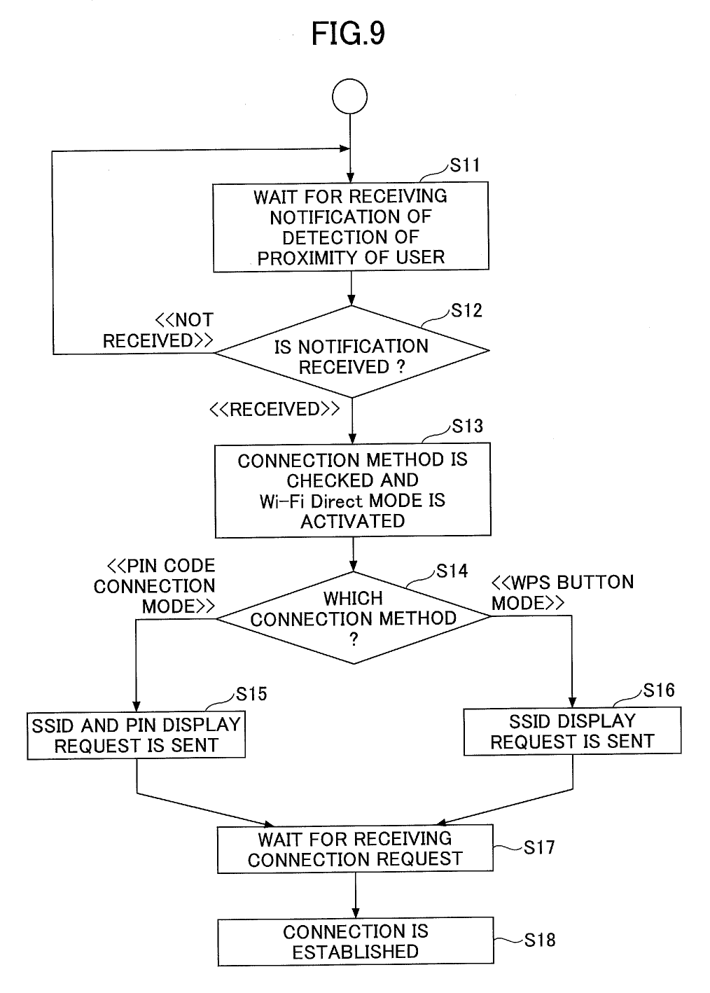

FIG. 9 is a flowchart for explaining a process performed by the network control unit 114 of the image forming apparatus 1 according to an embodiment. As shown in FIG. 9, the network control unit 114 is initially in a standby state waiting for a user approaching the image forming apparatus 1 until a notification of the proximity of a user is received from the device state determination control unit 111 (steps S11 and S12). When notification of the proximity of a user is not received, the network control unit 114 is continuously in a standby state or an energy-saving state waiting for the reception.

When the notification of the proximity of a user is received, the network control unit 114 checks a connection method of Wi-Fi Direct, activates the Wi-Fi Direct mode, and waits for a Wi-Fi Direct connection in accordance with the set-up connection method (steps S13-S17).

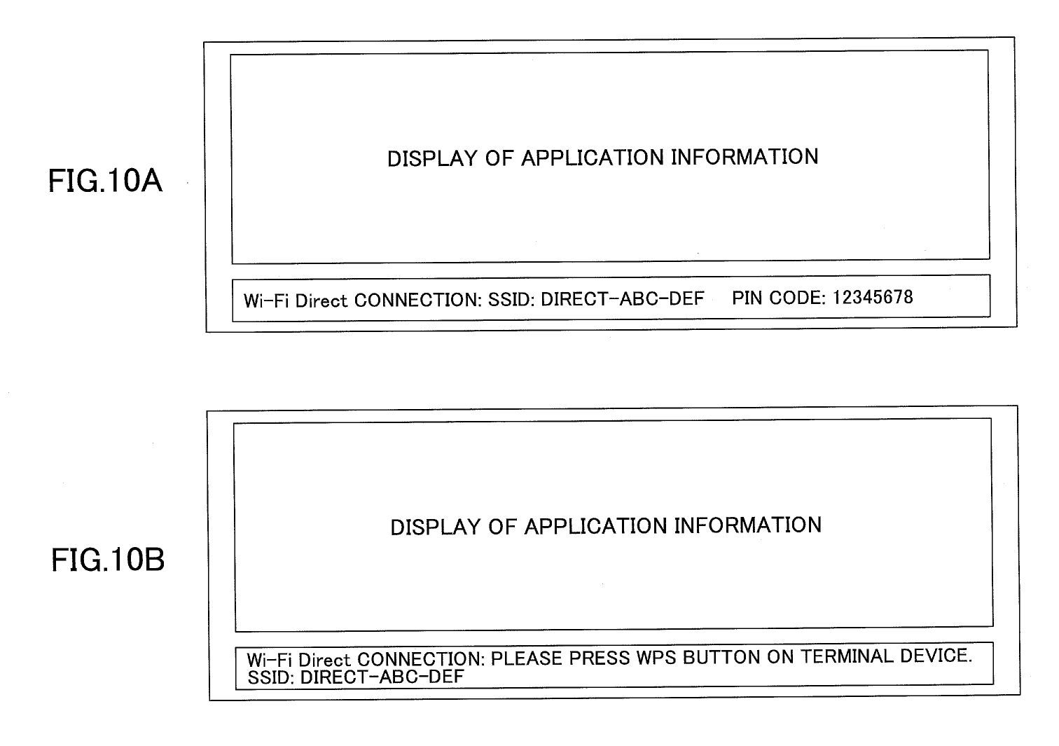

Namely, when the connection method is the PIN code connection mode at step S14, the network control unit 114 transmits an SSID and PIN display request to the operation unit 107 (step S15). FIG. 10A shows an example of a screen displayed by the operation unit 107 in response to the received request in this case. In the example shown in FIG. 10A, a message “Wi-Fi Direct CONNECTION: SSID: DIRECT-ABC-DEF, PIN CODE: 12345678” is indicated in a message indicator field at the bottom of the screen.

Referring back to FIG. 9, when the connection method is the WPS button mode at step S14, the network control unit 114 transmits an SSID display request to the operation unit 107 (step S16). FIG. 10B shows an example of a screen displayed by the operation unit 107 in response to the received request in this case. In the example shown in FIG. 10B, a message “PLEASE PRESS WPS BUTTON ON TERMINAL DEVICE. Wi-Fi Direct CONNECTION: SSID: DIRECT-ABC-DEF” is indicated in a message indicator field at the bottom of the screen.

Referring back to FIG. 9, the network control unit 114 waits for receiving a connection request from the user's terminal device (step S17), and performs, when the connection request is received, a user authentication process, and then establishes a Wi-Fi Direct connection between the image forming apparatus 1 and the terminal device (step S18).

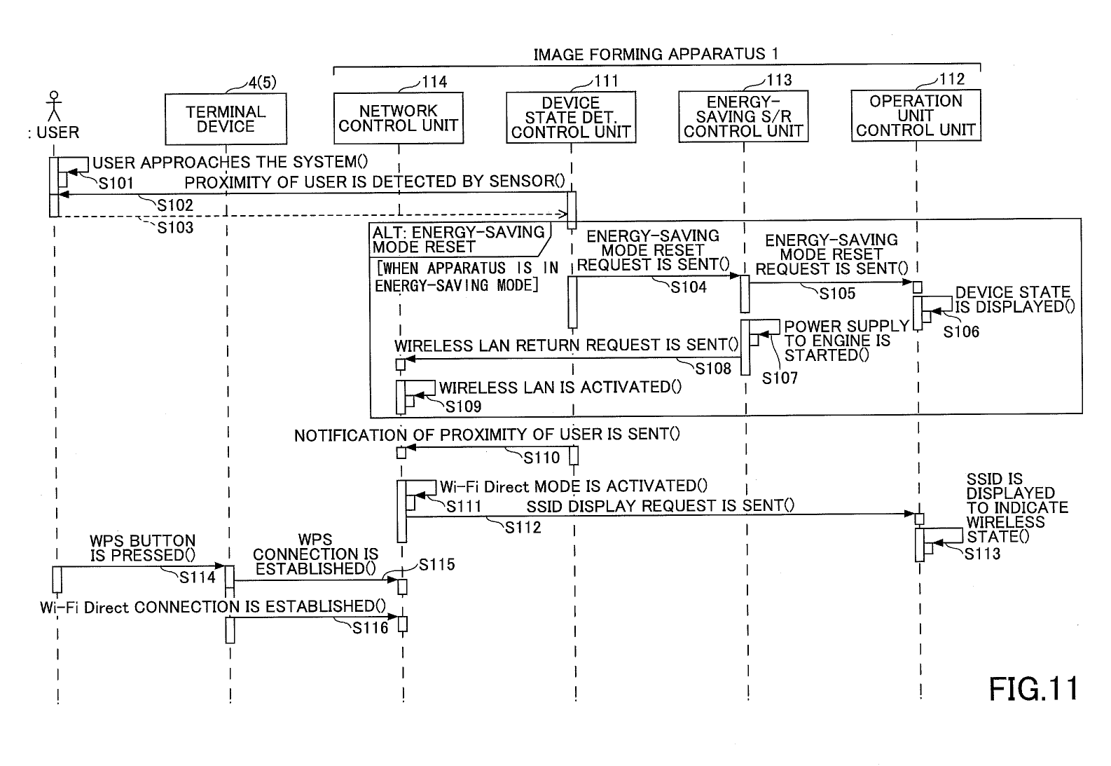

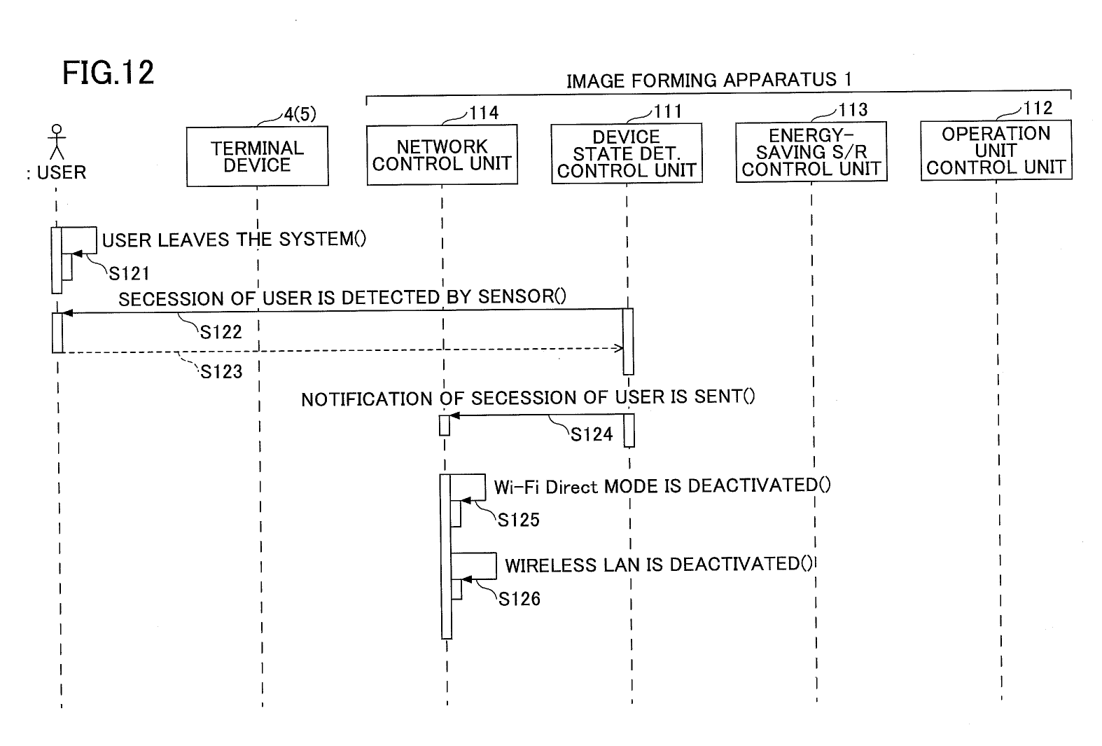

FIG. 11 and FIG. 12 are sequence diagrams for explaining a process by the system according to the above-mentioned embodiment. FIG. 11 shows a case in which a user approaches the image forming apparatus 1, and FIG. 12 shows a case in which the user leaves the image forming apparatus 1. In these diagrams of FIG. 11 and FIG. 12, it is assumed that the connection method is set to the WPS button mode.

As shown in FIG. 11, when a user approaches the system to use the image forming apparatus 1 (step S101), the device state determination control unit 111 of the image forming apparatus 1 detects the proximity of the user to the image forming apparatus 1 by using the human body detection sensor 108 (steps S102 and S103).

When the image forming apparatus 1 is in an energy-saving mode, the device state determination control unit 111 sends an energy-saving mode reset request to the energy-saving set/reset control unit 113 to reset the related module (step S104).

Similarly, the energy-saving set/reset control unit 113 sends the energy-saving mode reset request to the operation unit control unit 112 (step S105).

To return from the energy-saving mode, the operation unit control unit 112 turns ON the back light and causes the operation unit 107 to display a standby screen and a device state of the image forming apparatus 1 on the operation panel 11 (step S106).

The energy-saving set/reset control unit 113 starts the power supply to the engine board of the engine 105 (step S107), sends a wireless LAN return request to the network control unit 114, and causes the communication interface 109 to return from the energy-saving mode to a normal mode (step S108).

The network control unit 114 activates the wireless LAN if the wireless LAN was in an inactive state (step S109).

The device state determination control unit 111 sends a notification of the proximity of the user to the network control unit 114 (step S110).

The network control unit 114 activates the Wi-Fi Direct mode of the wireless LAN, and waits for receiving a Wi-Fi Direct connection request from the client (the terminal devices 4 and 5) (step S111).

After the Wi-Fi Direct mode is activated, the network control unit 114 sends an SSID display request to the operation unit control unit 112, which causes the operation unit 107 of the image forming apparatus 1 to display the SSID needed for a Wi-Fi Direct connection (step S112).

The operation unit control unit 112 causes the operation unit 107 to display the SSID of the image forming apparatus 1 to indicate a wireless state (step S113). This SSID is used on the side of the terminal device 4 or 5 for the checking when selecting the device of the connection partner.

The user presses a WPS button, which is displayed on the terminal device 4 or 5 by the WPS processing unit 43, to select the WPS mode of Wi-Fi Direct (step S114).

The terminal device 4 or 5 and the network control unit 114 of the image forming apparatus 1 perform the negotiation for the WPS connection (step S115) and establish a Wi-Fi Direct connection between them so that the network connection is completed (step S116). Subsequently, the user of the terminal device 4 or 5 inputs a job execution request from the application unit 41, such as requesting directly the image forming apparatus 1 to perform a printing job.

Next, as shown in FIG. 12, when the user leaves the system after an end of communication between the terminal device and the image forming apparatus 1 (step S121), the device state determination control unit 111 of the image forming apparatus 1 detects the secession of the user from the image forming apparatus 1 by using the human body detection sensor 108 (steps S122 and S123).

The device state determination control unit 111 sends a notification of the secession from the image forming apparatus 1 to the network control unit 114 (step S124).

The network control unit 114 deactivates the Wi-Fi Direct mode in response to the received notification (step S125). The network control unit 114 deactivates the wireless LAN if the wireless LAN was in an active state (step S126).

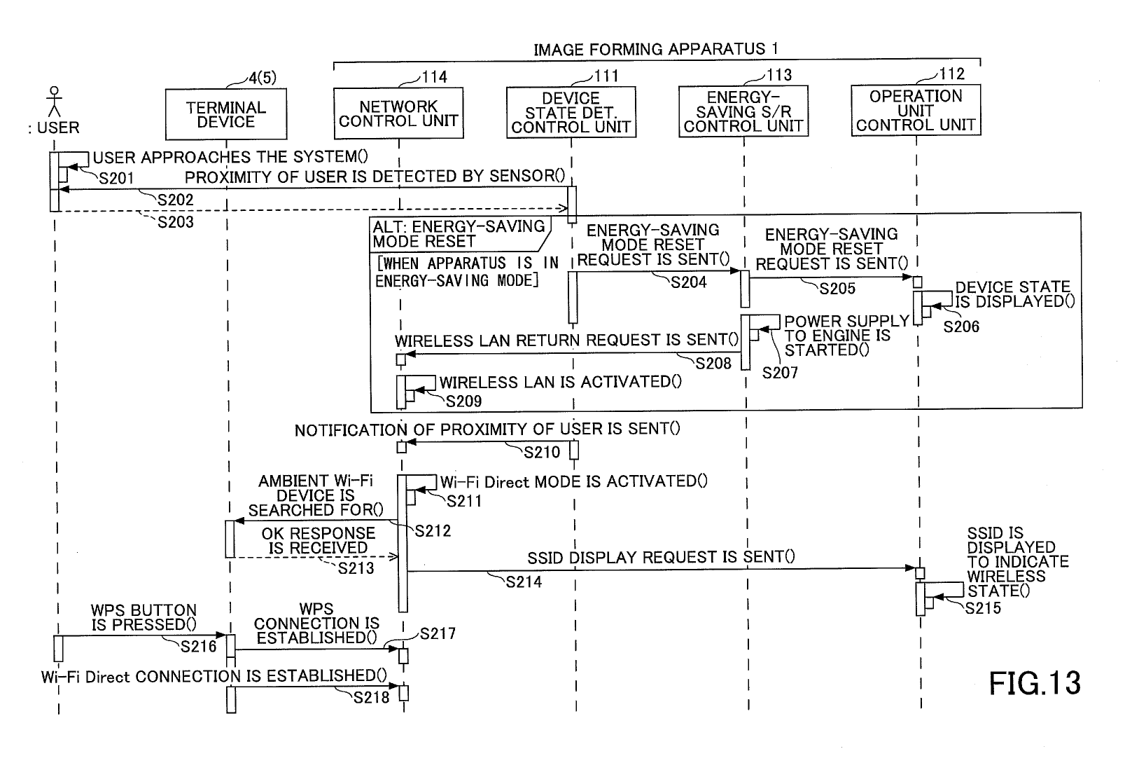

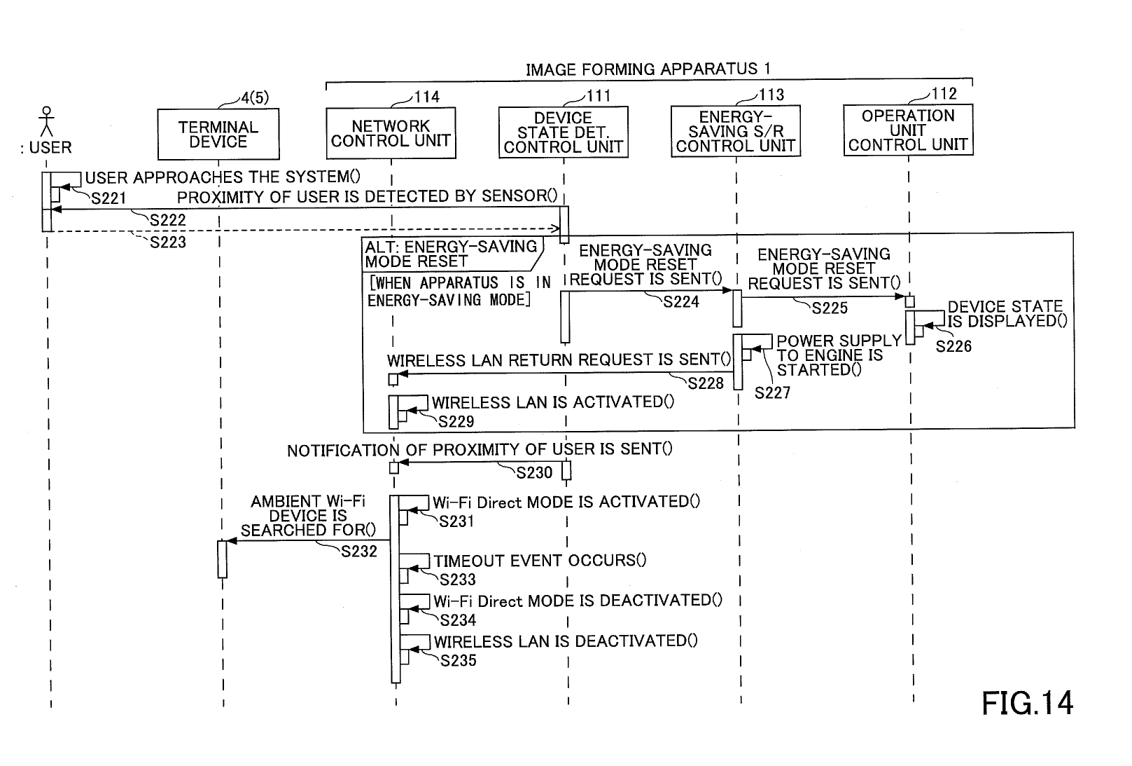

Next, FIG. 13 and FIG. 14 are sequence diagrams for explaining processes performed by the system according to modified embodiments. In the modified embodiments, after the Wi-Fi Direct mode is activated, it is determined whether a Wi-Fi apparatus exists in ambient environments, and only when the presence of a Wi-Fi apparatus in the ambient environments is detected, the SSID of the image forming apparatus 1 is displayed. Hence, in the modified embodiments, it is possible to prevent the SSID from being displayed unnecessarily.

In the process shown in FIG. 13, steps S201-S211 are the same as steps S101-S111 of the process shown in FIG. 11, and a description thereof will be omitted.

As shown in FIG. 13, after the Wi-Fi Direct mode of the wireless LAN is activated (step S211), the network control unit 114 searches for the presence of a Wi-Fi device in ambient environments of the image forming apparatus 1 (step S212).

When an OK response is received from the ambient Wi-Fi device, the network control unit 114 sends an SSID display request to the operation unit control unit 112, which causes the operation unit 107 of the image forming apparatus 1 to display the SSID needed for a Wi-Fi Direct connection (step S214). Subsequent steps S215-S218 of the process shown in FIG. 13 are essentially the same as those corresponding steps S113-S116 of the process shown in FIG. 11, and a description thereof will be omitted.

Next, in the process shown in FIG. 14, steps S221-S232 are essentially the same as those corresponding steps S201-S212 of the process shown in FIG. 13, and a description thereof will be omitted.

As shown in FIG. 14, after the presence of a Wi-Fi device in ambient environments is searched for (step S232), when a timeout event occurs in which a predetermined period has elapsed without receiving an OK response from the ambient Wi-Fi device (step S233), the network control unit 114 deactivates the Wi-Fi Direct mode (step S234) and deactivates the wireless LAN if the wireless LAN was in an active state (step S235).

As described in the foregoing, the Wi-Fi Direct mode can be activated automatically only when the user approaches the electronic device according to the invention, and it is possible for the electronic device according to the invention to provide improved operability and reduced power consumption.

The present invention is not limited to the above-described embodiments, and variations and modifications may be made without departing from the scope of the present invention. It is to be understood that the foregoing detailed description is exemplary and explanatory and is not restrictive of the invention as claimed.

The image forming apparatus 1 in the foregoing embodiments is an example of “electronic device.” The communication interface 109 in the foregoing embodiments is an example of “communication unit.” The Wi-Fi Direct mode in the foregoing embodiments is an example of “communication mode in which the electronic device and a terminal device communicate with each other directly.” The human body detection sensor 108 in the foregoing embodiments is an example of “human body detection unit.” The network control unit 114 in the foregoing embodiments is an example of “network control unit.”

Further, the network control unit 114 (performing the step S212 in FIG. 13) in the foregoing embodiments is an example of “search unit.” The operation unit control unit 112 (FIG. 8) in the foregoing embodiments is an example of “setting unit.”

Note that the electronic device according to the invention and the communication mode control method for use in the electronic device according to the invention may be implemented based on the disclosure of the foregoing embodiments. Further, a non-transitory computer-readable recording medium storing the communication mode control program which, when executed by a computer, causes the computer to implement the respective units of the electronic device according to the invention may be implemented based on the disclosure of the foregoing embodiments.

What is claimed is:

1. An electronic device comprising a processor, the processor including:
a communication unit configured to carry out a communication mode in which the electronic device and a terminal device communicate with each other directly;
a human body detection unit configured to detect proximity of a user to the electronic device; and
a network control unit configured to activate, in response to a notification of the proximity of the user detected by the human body detection unit, the communication mode by the communication unit in which the electronic device and the terminal device communicate with each other directly.

2. The electronic device according to claim 1, wherein the network control unit causes an operation unit to display a message that urges the user to perform an input operation, depending on a setting of a connection method, on the terminal device.

3. The electronic device according to claim 2, further comprising:
a search unit configured to search for presence of a terminal device in ambient environments of the electronic device,
wherein the network control unit causes the operation unit to display the message when the presence of the terminal device in the ambient environments of the electronic device is detected by the search unit.

4. The electronic device according to claim 1, wherein, when secession of the user from the electronic device is detected by the human body detection unit, the network control unit deactivates the communication mode by the communication unit so that the communication mode is set in an inactive state.

5. The electronic device according to claim 1, wherein, after an end of a communication between the electronic device and the terminal device, the network control unit deactivates the communication mode by the communication unit so that the communication mode is set in an inactive state.

6. The electronic device according to claim 1, further comprising:
a setting unit configured to receive an input communication mode setting selected by the user and set up the input communication mode setting in the network control unit.

7. The electronic device according to claim 6, wherein the setting unit is configured to receive from the user a value of a timeout interval between the end of the communication and a time the communication mode is to be deactivated after the end of the communication.

8. A communication mode control method performed by a processor of an electronic device including a communication unit configured to carry out a communication mode in which the electronic device and a terminal device communicate with each other directly, the method comprising:
detecting by the processor, proximity of a user to the electronic device; and
activating by the processor, in response to a notification of the proximity of the user detected, the communication mode by the communication unit in which the electronic device and the terminal device communicate with each other directly.

9. A non-transitory computer-readable recording medium storing a communication mode control program which, when executed by a processor of an electronic device, causes the processor to implement:
a communication unit configured to carry out a communication mode in which the electronic device and a terminal device communicate with each other directly;
a human body detection unit configured to detect proximity of a user to the electronic device; and
a network control unit configured to activate, in response to a notification of the proximity of the user detected by the human body detection unit, the communication mode by the communication unit in which the electronic device and the terminal device communicate with each other directly.
